(19) United States
(12) Patent Application Publication
(10) Pub. No.: US 2019/0147060 A1
(43) Pub. Date: May 16, 2019

(54) METHOD FOR AUTOMATIC GENERATION OF MULTIMEDIA MESSAGE

(71) Applicant: R2 IPR LIMITED, Hong Kong (CN)

(72) Inventor: Jack LAU, HONG KONG (CN)

(21) Appl. No.: 15/977,473

(22) Filed: May 11, 2018

(30) Foreign Application Priority Data
Nov. 10, 2017 (HK) 17111671.4

(51) Int. Cl. G06F 17/30; H04L 12/58

(52) U.S. Cl. CPC G06F 17/30029; G06F 17/28; H04L 51/10

(57) ABSTRACT

The invention is applicable to the technical field of data communication, and provides a method for automation generation of multimedia data. The method includes the following steps: S1, users inputting seed data information according to actual requirements; S2, analyzing the seed data information input by the users to extract weighing factors; S3, retrieving personal data information of recipients according to the weighing factors and extracting matched multimedia data information from a media database; and S4, integrating the seed data information with the multimedia data information matched with the personal data information to generate new multimedia messages. Through the method, work efficiency is improved, and operation time is shortened.

### BACKGROUND OF THE INVENTION

### Technical Field

The invention belongs to the field of technical improvements of multimedia message generation, and particularly relates to a method for automatic generation of multimedia message.

### Description of Related Art

At present, comprehensive entertainment clients integrating the functions of group chat, live video, karaoke, application games, online video and the like are widely applied to personal computers, mobile phones and other clients. In actual applications, users can sing songs via entertainment clients, the songs are then evaluated and graded via servers, and thus singing interaction is achieved.

Wherein, the one-to-multiple function is achieved in instant messaging and email sending; however, when one message is sent to multiple recipients through instant messaging clients or email clients, personalized variable customization for the recipients cannot be achieved. As time variables have to be customized one by one, work efficiency is low, and the user side has to adjust media factors such as the background by frequently operating one input instruction.

### BRIEF SUMMARY OF THE INVENTION

The invention provides a method for automatic generation of multimedia data to solve the technical problems of low work efficiency and frequent operation of one command message.

The method for automatic generation of multimedia data includes the following steps:

S1, users inputting seed data information according to actual requirements;

S2, analyzing the seed data information input by the users to extract weighing factors;

S3, retrieving personal data information of recipients according to the weighing factors and extracting matched multimedia data information from a media database; and

S4, integrating the seed data information with the multimedia data information matched with the personal data information to generate new multimedia messages.

As for a further technical scheme of the invention, the seed data information input in Step S1 includes one or the combination of several objects, video clips, animation, images, text information and voice data.

As for a further technical scheme of the invention, display objects highlighted in the input seed data information are set as variables by the users.

As for a further technical scheme of the invention, Step S2 further includes the following sub-steps:

S21, customizing a weighing factor for a certain specific recipient.

As for a further technical scheme of the invention, in Step S3, personal data information of the recipients is obtained through analysis on big data, social media feedback and embedded self-correction commercial messages about personal profiles/preferences.

As for a further technical scheme of the invention, Step S3 of extracting the matched multimedia data information from the media database includes the following sub-steps:

S31, searching an internal media database to judge whether matched media data information exists or not; if so, extracting the matched multimedia data information, and if not, performing the following sub-steps:

S32, searching an external media database for matched multimedia data information according to the weighing factors;

S33, screening the matched media data information searched-out and saving the matched multimedia data information in the internal media database.

As for a further technical scheme of the invention, in Step S3, the multimedia data information can be customized or freely matched.

As for a further technical scheme of the invention, in Step S3, a method for tagging video in the media database includes the following steps:

A1, extracting background music in the uploaded video and analyzing the genre and duration of the background music, saving comprehensive tags in the media database, and dissecting a still frame image into even or uneven intervals;

A2, saving comprehensive tags in the media database for the physical attributes of the still frame image and attached tags from a source.

As for a further technical scheme of the invention, Step A2 further includes the following sub-steps:

A21, converting each frame image into a text through image recognition engines such as TensorFlow;

A22, conducting natural language processing for all texts extracted from each frame image;

A23, saving comprehensive tags in the media database for each processed frame image.

As for a further technical scheme of the invention, the method for automatic generation of multimedia data further includes the following step:

S5, sending the generated multimedia messages to the recipients to automatically complete multimedia data transmission.

The invention has the beneficial effect that work efficiency is improved and operation time is shortened. This method is simple, easy to operate and can achieve the effect of customized messages for multiple recipients only through sending once.

### BRIEF DESCRIPTION OF THE SEVERAL VIEWS OF THE DRAWINGS

FIG. 1 is a flow diagram of a method for automatic generation of multimedia data in the embodiment of the invention.

FIG. 2 is a diagram of photo 1 in the embodiment of the invention.

FIG. 3 is a diagram of photo 2 in the embodiment of the invention.

FIG. 4 is a diagram of photo 3 in the embodiment of the invention.

FIG. 5 is a diagram of a background photo of a resort hotel and photos of dim sum in the embodiment of the invention.

FIG. 6 is a diagram of photos of facilities and a sports field of a resort hotel in the embodiment of the invention.

FIG. 7 is a diagram of the output of a speech into an NLP (natural language processing) parser.

FIG. 8 is an example of segmentation.

FIG. 9 shows the parser notation and corresponding weighting in the example sentence.

FIG. 10 shows a template with three photos (a collage).

FIG. 11 shows how the scrambler chooses the best image.

FIG. 12 shows some possible criteria in the example of the resort hotel.

### DETAILED DESCRIPTION OF THE INVENTION

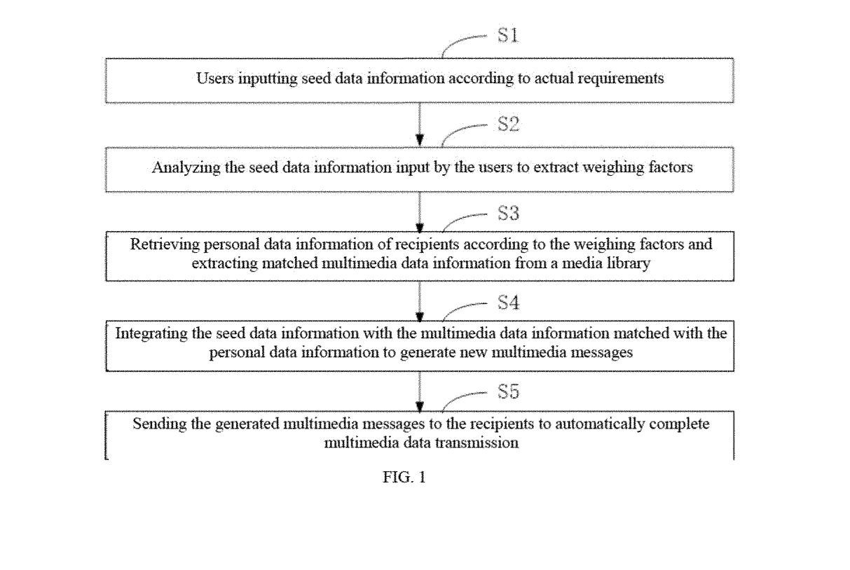

As is shown in FIG. 1 which is a flow diagram of a method for automatic generation of multimedia data of the invention, a detailed description of the method is as follows:

Multimedia refers to, but not limited to, video, animation, augmented reality, virtual reality, multidimensional clips, and audio. Users can decide to create a multimedia message based on certain objects, video, texts, voice and/or image (considered as ‘seeds’) chosen by the users. These seeds are then analyzed based on image recognition, video analysis, text analysis, voice recognition to generate a new multimedia message.

The method includes the following steps: S1, users inputting seed data information according to actual requirements, specifically, if a still image or a number of still images is/are entered as ‘seed’, image recognition is performed. Based on or any image recognition engines such as TensorFlow, such images can be converted into tags such as text description, mood, theme, appearance, geographic location, cultural context, gender/sex/race/age (if people are in the images). Other physical attributes such as the size of the images and photography (the choice of cameras and notes of photographers) can also be extracted. Thus, a rich tag consisting of all the above content is then used to generate, for instance, a video message.

Users may or may not indicate what should be emphasized. Depending of accessibility, video based on the ‘seed’ image is either retrieved from a fixed database or ‘crawled’ from the Internet. The compositions of the multi-media message are ‘stitched’ together to maximize the aesthetic sense and duration while true to the theme of the ‘seed’. Music, text caption, animation can be augmented.

S2, analyzing the seed data information input by the users to extract weighing factors, specifically, all ‘seeds’ is parsed through neural networks like algorithms to identify major features. For instance, if a still image is planted as a seed, object recognition is performed. A user interface highlights the ‘weighting’ of all elements in the seed.

As an example, as described previously, if an image of a romantic couple drinking coffee with the Eiffel Tower as the background is used as a ‘seed’, image recognition is performed to determine that a couple is drinking coffee. Users can highlight the Eiffel Tower by drawing a line around the tower. Next to the line, the users can enter attributes such as ‘variable’. At the same time, the users can also highlight the romantic couple but enter the attribute ‘constant’.

In another specific embodiment, the neural network algorithm can be used for converting the image into a text. In the text of the above image, users can see words such as ‘A Man and a Woman are Drinking’. Depending on the processing power allocated and the training of the neural network, some of the objects may not be recognized. (For instance, it is possible that the text converted from the image misses the Eiffel Tower completely.) It is more important to highlight objects that are of higher weighting. The algorithm treats all other objects as variables. However, if an object is not recognized by the image and is assigned a higher weighting and the user decides to highlight what is important or not, then the user has the option of going back to the image itself to do the highlight or doing an inverse of the text to highlight what has been identified through image to text as NOT important.

If the entire ‘seed’ is text, the users can highlight specific word(s) to emphasize the ‘weighting’ of these words. These highlights can be made by simply being turned into bold, italics, underline, or any of the conventional typing practices. More options can be made available, for instance, to indicate which are to be the ‘variables’ in the event of requiring dynamically generating clips based on different circumstances, environmental changes, or new inputs.

If the ‘seed’ is based on voice, the user can dictate what is important or not through voice, or wait for the voice to text conversion and set the weighting in the text format.

S3, retrieving personal data information of recipients according to the weighing factors and extracting matched multimedia data information from a media database, specifically, users can broadcast multimedia messages to a group of highly diversified people. The genesis of the message can be text based. However, on the receiver end, the received message will be a multimedia clip. Based on certain profiles and preferences of the receiver, the clip can be dynamically adjusted to best meet requirements of the receiver.

A method is described in which users can send multiple messages which are automatically generated with a possible mixture or presence of the likes of video, photos, animation, music and texts to a number of recipients. (The message does not have to contain all media type. For instance, certain messages may or may not have video.) However, the message received by each recipient can be different in terms of theme, arrangement, content, duration, music, voice-over, caption, text, and other attributes. While the users can choose a central theme based on submission of certain data, the multimedia message is generated based on profiles of the recipients and other attributes (such as ‘friends’ groups or other parameters of the recipients).

In one example, during a festive holiday such as Christmas, a user can send out a Christmas greeting message to all contacts (such as ‘Friends’) on social media sites such as Facebook. The user can choose to have his own image such as his mugshot (like his ‘head’) dynamically attach to a cartoon figure such as a Santa Claus. This animation is then overlaid to particularly customized video or photos according to the profiles of the recipients. For instance, if his friend (the recipient) is shown to be a dog lover on his Facebook page and lives in Boston, the animation will be overlaid to video or photos of cute pets or Boston skylines. On the other hand, if his friend has multiple photos together with the user (sender), the animation will be overlaid to those photos taken together, for instance. Commercial sponsors (advertisements) may be embedded anywhere in the greeting message.

S4, integrating the seed data information with the multimedia data information matched with the personal data information to generate new multimedia messages, specifically, in order to generate a new multi-media message, a database of images, animation (the animation vector can be programmable), videos, music needs to be ready. Since in some applications, the method allows dynamic generation, the speed to generate the new multi-media messages is of essence. One important element to quickly build up the new multi-media message is to have a database ready and well tagged.

Tagging for both video (still images, video and animation) and audio (music and voice-over) are analyzed a-priority.

As an example, for motion video in the database, a still image is extracted from the motion video at intervals (every 2 second, for instance). These extracted frame images are then analyzed scene by scene. Essential features such as object description, action, background lighting, sentiment analysis, and geographical location are extracted and used as tags. Physical attribute tags such as resolution are also tagged for each frame. The attributes of the individual frames are aggregated to form an overall attribute of the video in the database.

When the multi-media message is created through the database, it is highly possible that only certain frames of a single video in the database are used. For instance, in creating the multi-media message, only the frames from frame X to frame Y (of the entire video) are used.

To further facilitate the generation of multimedia, certain media in the database or even from external sources can be used as a reference. Users can request to take the media as the ‘reference’. When such a request is made, the corresponding algorithm will be deployed to do a scene-by-scene analysis and to extract essential features such as object description, action, background lighting, duration, sentiment analysis, and geographical location. These features are passed through potentially a neural network. The artificial intelligence then contrasts given templates and generates a new multimedia clip.

As an example, users can send in a media clip and request to ‘more like that’ content, but with certain different emphasis, such as duration, change of characters and insertion of some images.

One application is that an advertisement company has created a model story board. However, to launch in different countries, the advertisement company prefers to have a video advertisement with a similar look and feel, yet inserting more local cultural content. In one example, a romantic couple is having coffee in a Paris cafe with the Eiffel Tower as the background, and towards the end, the logo of the advertiser appears. In this video, the essence is the ‘romantic couple drinking coffee’ and the ‘logo of the advertiser’. The geographical location of Paris is secondary and needs to be a variable. So, if the advertiser decides to launch a similar video in America, the media is still a romantic couple drinking coffee and the logo of the advertiser still appears at the end. However, the background of the video is American icon, such as the Golden Gate Bridge or the Statue of Liberty. By the same token, if the advertisement is to be launched in Japan, the similar romantic couple is drinking coffee with the Japan landmark such as the Tokyo TV tower as the background. The background music for the three videos can be adjusted if needed.

S5, sending the generated multimedia messages to the recipients to automatically complete multimedia data transmission. As the multi-media message needs to be viewed on multiple platforms and perhaps in different geographic location, cultural differences, data bandwidth limitations, screen sizes and applications for seeing the multi-media message can all affect the viewability of the multi-media message.

For instance, in an application such as Snap or Instagram, where viewers tend to watch a shorter video, the multi-media message is shorter in duration. However, in an environment such as YouTube or Facebook, the same message can be played longer. Or in some cases, the same multi-media message will have different versions. A shorter one will be delivered if interests of the shorter one are proven. A longer version will be delivered if interests of the longer version are proven.

Commercial Applications:

a, Greeting Cards: using Chat bot, users can create and customize various videos such as Christmas cards for a large number of recipients. The videos can be highly customized based on the preferences of users and/or the profiles of recipients and feedbacks. For instance, names of the recipients are automatically inserted. Photos containing both the recipients and the users can be automatically inserted into each card. (Such images can be automatically extracted from either a social media page or a user photo database based on face tags, for instance.)

b, Promotional Offers: Within these multimedia messages (can be video), advertisements/coupons can be embedded. The offers can be tailored-made based on the profiles of expected users.

c, Creating Multimedia Messages with ‘Just like that’ features using the ‘reference media’ function, users such as advertisers can create similar videos but with different selected components and/or attributes such as duration to a wide array of audience.

d, Kickstarter Campaigners: Users in crowd funding such as Kickstarter are usually required to create a master video to be posted on the Kickstarter web page. Users can firstly use the ‘Just like that’ feature to create master video. Users can also pick a video they like and use the method disclosed in the patent to create another version. Moreover, in a typical Kickstarter campaign, users need to follow up with the posting on the Kickstarter web page according to the marketing campaign. In using the method disclosed in the patent, users can create multiple tailored-made multimedia messages to a wide array of potential customers, such as themes, feature (of customer products) emphases (for instance, certain end customers can be more easily moved by technological innovation, while some maybe by aesthetic, and some by pricing, or emotional attachment), on media such as Facebook or YouTube. The method is important because in the follow up campaign, the multimedia messages usually are short and Kickstarter campaigners are cost sensitive.

e, Government Policy Campaign: In promoting a certain government policy, the government in the past relied on one-size-fit-all messages and traditionally relied on TV for media campaign. Now, government officials can promote certain messages through social media to appeal to individuals differently. For instance, in a ‘No smoke’ campaign, a message to a future father to stop smoking can appeal to him the potential harm to a baby. At the same time, to another adult, the message can be that smoking can cause cancer making him/her unable to care for his/her family. For the younger generation, the message can be ‘not cool’. Based on the profile of the individual as appeared in social media (such as WeChat or Facebook), officials can automate messages. The emphasis is that the multimedia messages generated are aware of both the profile of the sender and the profile of the receiver.

f, Advertisers: On social media (such as Facebook Messenger), companies tailored the messages such as product introductions, offers, personal greetings (such as birthday offerings) to individuals based on the profiles of users. According to the method disclosed in the patent, the profiles of users are also considered and learned. For instance, if an insurance agent sends out a birthday message to his/her client, the greeting message preference of the agent is obtained from both the profile and historical preferences of the agent.

g, Campaign Changing and Personalized Customization on Advertisement Flyers: In a product media campaign, companies send out commercial advertisements (or infomercials) based on different feedbacks of users. The dynamic feedbacks allow companies to quickly change the campaigns on the flyers. In the past, a campaign is usually launched in a batch (the ‘shot gun’ approach). Now, the campaigner can select to send out the message to a small sample first to collect data. After receiving the feedback, the campaigner can generate a more optimized campaign message.

h, Augmented Reality Real Time Dynamic Video Generation: In augmented reality, video needs to be generated to supplement real background scenes. According to the information such as user preferences, the method disclosed in the patent allows ways to generate different multimedia messages based on different objects in the ‘reality’ background and to achieve dynamic adjustments based on the user profile. For instance, in a background image where a bottle of beer and a toy appear, the generated multimedia video message at the foreground can be a message on discounted pizza if the focus is on the beer for an adult, but the message can be changed into a discounted ticket to an amusement park if the focus is on the toy for a child.

i, Potential Users: Groupon, Kickstarter campaigners, insurance companies, private clubs, international brands, governments, individuals and small-and-medium size enterprises.

For manual input, based on the ‘seed’, users can specify a linear scale such as 1 to 10 and specify how significant the seed is. Example, ‘An Asian Girl is Drinking a Cup of Coffee’ is taken as a text input. (In this example, a text sentence is used for illustration. If the ‘seed’ is a photo, a graphical interface or a processed image can be converted into a text in advance.)

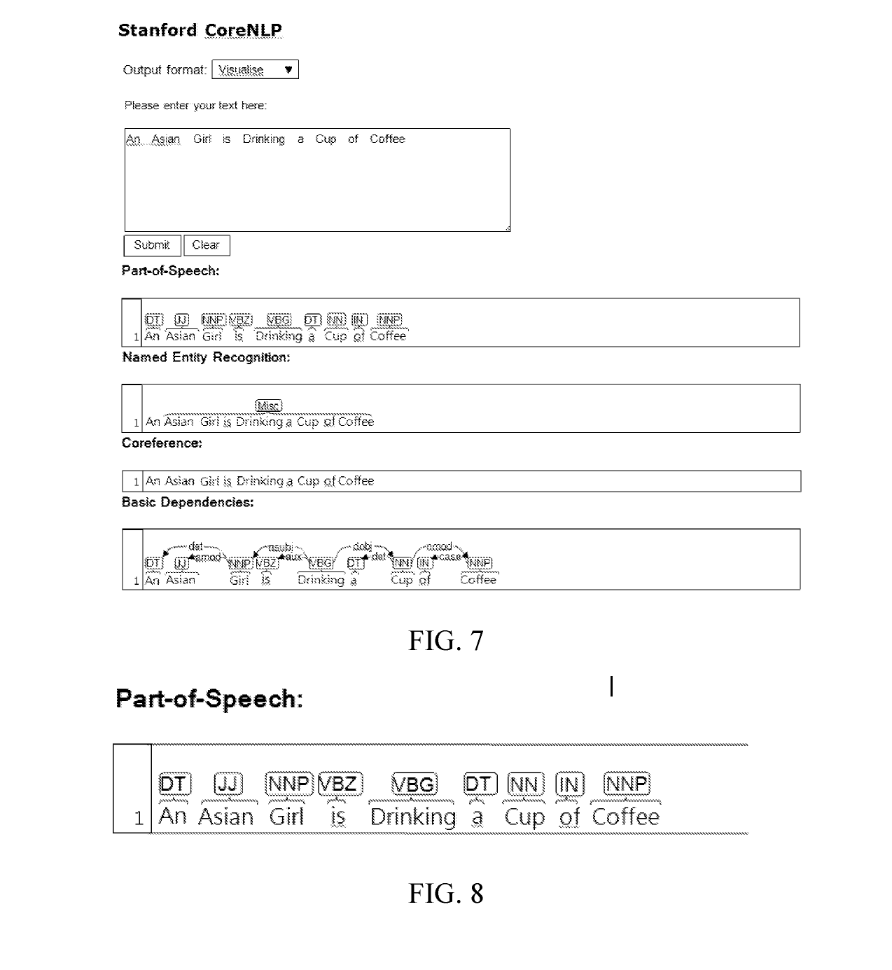

If one passes the above speech into an NLP (natural language processing) parser, the output can be shown as in FIG. 7.

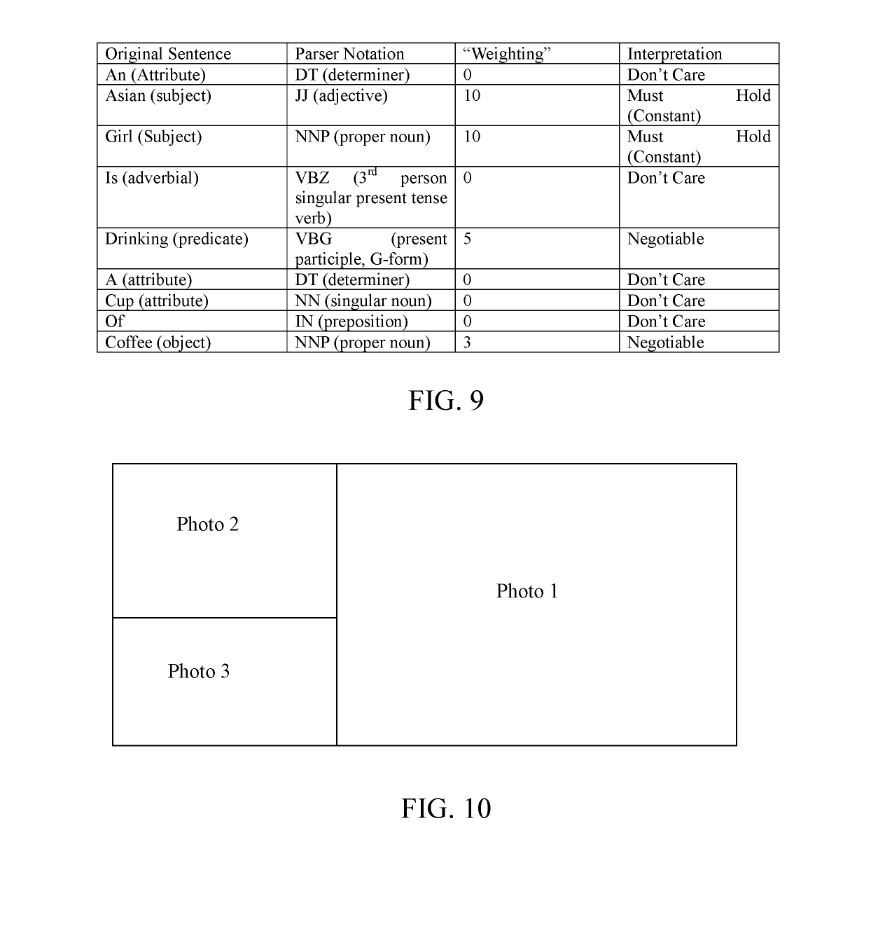

For easy reference, emphasis is only laid on the segmentation in the examples as shown in FIG. 8. As shown in FIG. 9, it shows the parser notation and corresponding weighting in the example sentence.

Based on the above criteria, the algorithm will look for the most appropriate photo that represents these criteria. (As a note, the above syntax is only a subset of all possible notations.)

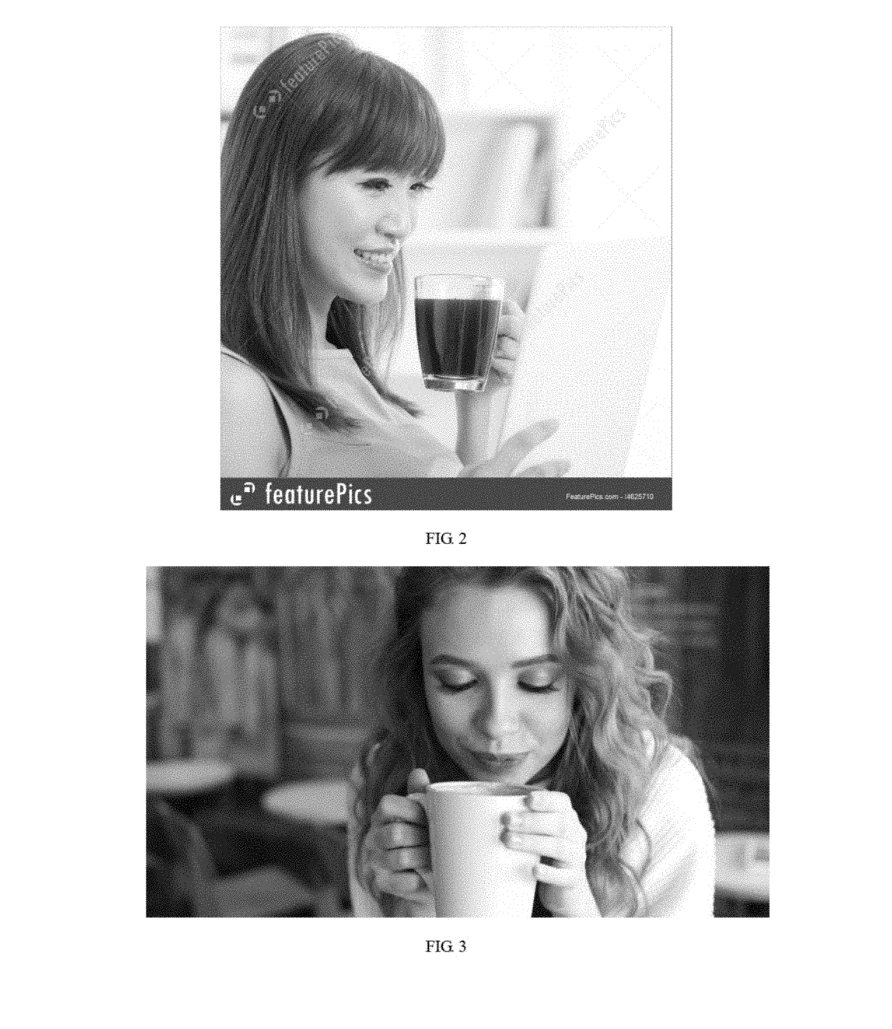

As is shown in FIG. 2, in photo 1, we see an Asian female drinking a cup of coffee.

As is shown in FIG. 3, in photo 2, we see a non-Asian female drinking a cup of coffee.

As is shown in FIG. 4, in photo 3, we see an Asian female drinking a glass of water.

Therefore, based on the criteria set in the example, photo 1 is more likely the choice, rather than photo 2 or 3.

However, if the weighting is adjusted, for example, the adjective (‘Asian’) is set to a lower weighting, both photo 1 and photo 2 can be selected.

Auto Weighting (‘Scrambler’)

In another scenario, weighting can be set to be automatic, in which case users can select to choose images based on several possible external inputs (specifics of the sender, the profile of the receiver, or social media data).

As an example, imagine the case that an advertising email of a resort hotel is about to be sent to international clients.

In this example, a template with three photos (a collage) as shown in FIG. 10 can be chosen by users. In this example, a collage of three photos is required. In the collage, photo 1 is designated a ‘constant’ with the highest weighting factor. (Note: the template is designed in this way.) Photo 2 and Photo 3 are generated automatically according to the weighting factor assigned to the template based on inputs about the profiles of receivers and social media content.

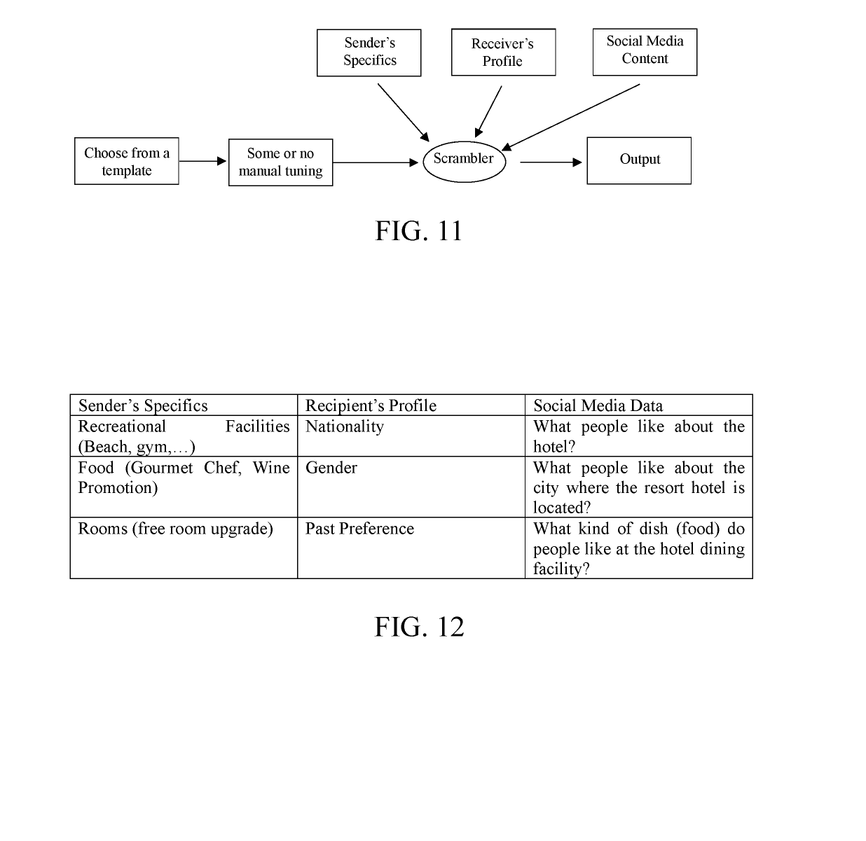

Once a part of the photo is allowed to be automatically selected through the scrambler, users can then allow the scrambler to choose the best image as shown in FIG. 11. In certain cases, the criteria for the scrambler are pre-defined based on the industry and applications or by users.

In the example of the resort hotel, here are some possible criteria as shown in FIG. 12. In this example, all the factors are assigned with equal weighting and image can be picked at random.

In one possible algorithm, the background photo of the resort hotel depends on the ‘past preference’ of the receiver (the hotel guest) and the social media having been commented on (what people give the most stars).

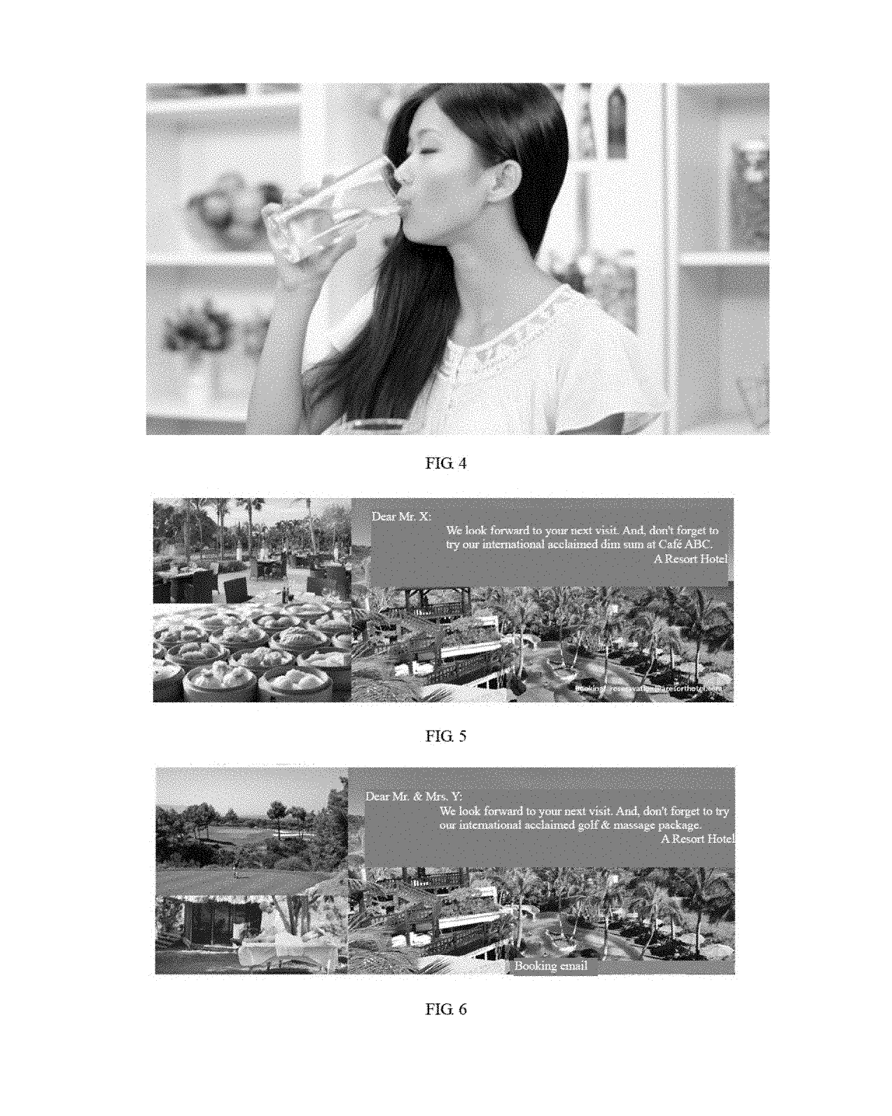

In the above example, in a hotel email blast, if the receivers often go out for dining, then the best background photos are about food and restaurant. As to what food needs to highlight, the scrambler can refer to the nationality of the receivers and the comments on the social media. For instance, if the receivers are from Hong Kong, and comment most about dim sum in a social media such as OpenRice.com (a site which is frequently used by Hong Kong residents), the best background photo could be one with the dining facility and promotional photos of dim sum, as is shown in FIG. 5.

In another scenario, if the personal profile indicates that the receiver is a golfer and he comments mostly about massage and SPA services at the hotel in social media platforms, the output will be a collage of golf courses, massage services and the hotel. Based on this, the message text would correspondingly illustrate the information, as is shown in FIG. 6.

The above embodiment is only a preferred embodiment of the invention and is not used for limiting the invention. All modifications, equivalent substitutes and improvements made based on the sprit and principle of the invention are within the protection scope of the invention.

What is claimed is:

1. A method for automatic generation of multimedia message, characterized by including the following steps:
S1, users inputting seed data information according to actual requirements;
S2, analyzing the seed data information input by the users to extract weighing factors;
S3, retrieving personal data information of recipients according to the weighing factors and extracting matched multimedia data information from a media database; and
S4, integrating the seed data information with the multimedia data information matched with the personal data information to generate new multimedia messages.

2. The method for automatic generation of multimedia message according to claim 1, characterized in that the seed data information input in Step S1 includes one or the combination of several objects, video clips, animation, images, text information and voice data.

3. The method for automatic generation of multimedia message according to claim 2, characterized in that display objects highlighted in the input seed data information are set as variables by the users.

4. The method for automatic generation of multimedia message according to claim 2, characterized in that Step S2 further includes the following sub-steps:
S21, customizing a weighing factor for a certain specific recipient.

5. The method for automatic generation of multimedia data according to claim 2, characterized in that in Step S3, personal data information of the recipients is obtained through analysis on big data, social media feedback and embedded self-correction commercial information about personal profiles/preferences.

6. The method for automatic generation of multimedia data according to claim 4, characterized in that Step S3 of extracting the matched multimedia data information from the media database includes the following sub-steps:
S31, searching an internal media database to judge whether matched media data information exists or not; if so, extracting the matched multimedia data information, and if not, performing the following sub-step:
S32, searching an external media database for matched multimedia data information according to the weighing factors;
S33, screening the matched media data information searched-out and saving the matched multimedia data information in the internal media database.

7. The method for automatic generation of multimedia message according to claim 5, characterized in that in Step S3, the multimedia data information can be customized or freely matched.

8. The method for automatic generation of multimedia message according to claim 6, characterized in that in Step S3, a method for tagging video in the media database includes the following steps:
A1, extracting background music in the uploaded video and analyzing the genre and duration of the background music, saving comprehensive tags in the media database, and dissecting a still frame image into even or uneven intervals;
A2, saving comprehensive tags in the media database for the physical attributes of the still frame image and attached tags from a source.

9. The method for automatic generation of multimedia message according to claim 6, characterized in that Step A2 further includes the following sub-steps:
A21, converting each frame image into a text through image recognition engines;
A22, conducting natural language processing for all texts extracted from each frame image;
A23, saving comprehensive tags in the media database for each processed frame image.

10. The method for automatic generation of multimedia message according to claim 1, characterized by further including the following step:
S5, sending the generated multimedia messages to the recipients to automatically complete multimedia data transmission.
